(19) United States
(12) Patent Application Publication
(10) Pub. No.: US 2025/0307844 A1
(43) Pub. Date: Oct. 2, 2025

(54) Generative AI Based Medical Insurance Claim Fraud Wastage and Abuse Detection System

(71) Applicant: MediConCen Limited, Hong Kong (HK)

(72) Inventors: Kwong Wing YEUNG, Hong Kong (HK); Kwong Yip YEUNG, Hong Kong (HK)

(21) Appl. No.: 18/795,350

(22) Filed: Aug. 6, 2024

(30) Foreign Application Priority Data
Apr. 2, 2024 (HK) 32024089520.3

(51) Int. Cl. G06Q 30/018; G06N 3/0455; G06N 3/0475; G06N 3/094; G06Q 40/08

(52) U.S. Cl. CPC G06Q 30/0185; G06Q 40/08; G06N 3/0455; G06N 3/0475; G06N 3/094

(57) ABSTRACT

The invention employs three distinct models, each tailored to offer the most accurate prediction in determining whether a given medical insurance claim qualifies as a fraud, waste, or abuse case. These models operate independently, yet their outputs are combined to ensure a comprehensive evaluation. The invention assigns weights to the votes cast by each model, reflecting their relative importance and reliability. This weighted approach ensures that the final classification-whether the case is fraud, waste, or abuse—is based on a balanced consideration of all available evidence. The result is a robust and dependable system that can handle the complexities of fraud detection, waste management, and abuse prevention in a variety of settings, including financial institutions, healthcare organizations, and government agencies.

### TECHNICAL FIELD

The invention pertains primarily to the realm of data analytics, and more specifically, it concerns the visualization of analytics within a generative AI-based medical insurance claim fraud, wastage, and abuse detection system.

### BACKGROUND

The significance of AI in detecting medical insurance fraud cannot be overstated. It serves as a pivotal tool in tackling the widespread menace of fraudulent activities within the healthcare system. These fraudulent practices have the potential to cause significant financial losses and inflate healthcare costs for insurers, patients, and providers alike.

By leveraging advanced algorithms and machine learning techniques, AI is capable of analyzing vast amounts of claims data at remarkable speeds. This technology is adept at identifying patterns and anomalies that would be virtually impossible for humans to detect within a reasonable timeframe. This proactive detection is pivotal in preventing monetary losses and maintaining the integrity of the healthcare system. The application of AI in fraud detection ensures that healthcare resources are utilized appropriately. It also assists in keeping insurance premiums affordable for legitimate patients. Furthermore, it contributes significantly to the overall efficiency and sustainability of healthcare services. Beyond its financial implications, AI-driven fraud detection plays a crucial role in fostering trust in the medical insurance system. It ensures that funds are not diverted by fraudulent activities, which can erode the quality of patient care and the financial stability of providers. By protecting the system from such malicious practices, AI helps to preserve the trustworthiness and reliability of the healthcare system, benefiting both patients and providers alike.

The employment of AI in medical insurance fraud detection is not only critical for preventing financial losses but also for safeguarding the integrity and sustainability of the healthcare system. Its ability to process vast amounts of data quickly and accurately makes it an invaluable asset in the fight against fraudulent activities.

### SUMMARY

Traditional AI models primarily rely on historical data and mimic human decision-making processes. However, this invention takes a different approach, harnessing cutting-edge generative AI to introduce fresh knowledge, particularly in the medical domain. This innovative method complements traditional supervised and unsupervised learning techniques, which primarily focus on learning from historical data and human expertise. By incorporating state-of-the-art generative AI, this invention aims to enrich the modeling process with new insights and understandings, particularly in areas where traditional methods may fall short. This approach not only enhances the accuracy and effectiveness of AI models but also broadens their application scope, enabling them to make more informed and innovative decisions. By bridging the gap between traditional AI and cutting-edge generative technologies, this invention aims to revolutionize the way AI is used in various fields, including medicine, where it can play a pivotal role in improving patient outcomes and healthcare efficiency.

This invention seamlessly integrates three distinct models to enhance claim fraud detection and prevention. Firstly, an unsupervised model is employed, which learns by observing data and employs similarity and clustering analysis to identify abnormal behaviors and outliers, such as gender and surgery mismatches, as well as abnormal prescriptions. This model operates independently of human knowledge, leveraging the K-means algorithm for unsupervised learning.

Secondly, a supervised model is introduced, which learns from human past decisions and mimics human reasoning in identifying fraud, wastage, and abuse. This model utilizes machine learning techniques to understand the correlation between inputs and human decisions, establishing relationships without the need for rule engines. The XGBoost algorithm powers this supervised learning approach.

Lastly, a GenAI model is harnessed, leveraging the power of generative AI with proprietary enhancements. Trained on over 570 GB of all-purpose text data, this model possesses the latest medical and insurance knowledge, including medical expertise that surpasses the US Medical Licensing Exam standards. It adjudicates cases with human-like reasoning, drawing from the latest ChatGPT 4 model by OpenAI.

Each of these models independently makes predictions about whether a claim case is fraudulent, wasteful, or abusive, prioritizing precision. The invention then combines the results of these three models, labeling a case as fraudulent, wasteful, or abusive through a weighted voting system. This integrated approach offers a comprehensive and multi-faceted solution for enhancing claim fraud detection and prevention.

This invention offers several unique features that differentiate it from prior art:

1. It utilizes generative AI to emulate medical domain experts, enabling the system to evaluate medical cases for necessity and reasoning. This approach ensures a more comprehensive and accurate assessment of medical cases.

2. The invention incorporates the judgements of generative AI into the training of its supervised and unsupervised models. This innovative combination of human-like reasoning and machine learning techniques enhances the models' ability to detect fraud, wastage, and abuse.

3. A customized loss function is employed during model training, which is based on the actual financial loss incurred by an insurer due to fraudulent claims. This loss function ensures that the models are optimized to minimize the FWA (fraud, wastage, and abuse) loss, rather than relying on traditional measures like squared errors. This approach leads to more effective fraud detection and reduced financial losses for insurers.

If a case is a fraud but it is flagged as not fraud, FWA Loss=Amount requested.

If a case is a fraud but it is flagged as fraud, FWA Loss=investigation cost=Investigation Cost.

If a case is not a fraud but it is flagged as fraud, FWA Loss=investigation cost+reputation damage.

4. This invention is the first to combine supervised, unsupervised, and expert models based on generative AI to maximize the effectiveness of fraud detection. This groundbreaking approach significantly improves the accuracy of results, surpassing prior art solutions.

5. The use of generative AI to provide commentary on the reasoning behind the classification enables insurance company claim staff to understand and confirm the accuracy of the detection system. This commentary, delivered in human language, can be quickly verified by educated individuals and used to dispute claims with concerned medical providers. This advancement in explainability makes the results from AI more actionable and enhances communication between claim staff and medical providers. Other AI models lack this ability to provide unscripted, human-language explanations, limiting their usability and impact.

6. Prior art similar AI model would give a fixed number of feedback like field A and field B is the top reason AI believes the case is a fraud. This model with generative AI gives essentially unlimited combinations of text based explanations, which is more useful for claim staff to understand the reasons behind.

### BRIEF DESCRIPTION OF THE DRAWINGS

Having thus described the invention in general terms, reference will now be made to the accompanying drawings, which are not necessarily drawn to scale, and wherein:

FIG. 1 shows sequential tree building in XGBoost with residual corrections.

FIG. 2 shows original data points (a two-dimensional scatter plot featuring a total of 12 data points).

FIG. 3 shows clustered datapoints with circled clusters. These points have been organized into 3 distinct clusters. Points in close proximity to each other are grouped into the same cluster. The perimeter of each cluster is delineated by a curve, each in a unique color to differentiate one cluster from another. At the heart of each cluster is the centroid, highlighted by a star icon, which is color-coordinated with the boundary of its respective cluster.

FIG. 4 shows set of data points with random centroid initializations.

FIG. 5 shows assignments centroid locations updated as average of points assigned to each cluster.

FIG. 6 shows assigning points based on updated centroid locations (FIG. 7).

FIG. 7 shows updated centroid locations updated location of centroids given by cluster averages.

FIG. 8 shows flow diagram of loss function.

### DETAILED DESCRIPTION

This invention merges three distinct models to enhance the detection and prevention of claim fraud. Each model independently analyzes claim cases, making predictions about their fraudulent, wasteful, or abusive nature, with a focus on precision.

The invention then collates the results of these models, utilizing a weighted voting system to determine whether a case should be labeled as fraudulent, wasteful, or abusive.

This holistic and multifaceted approach offers a robust solution for enhancing claim fraud detection and prevention, ensuring a more comprehensive and accurate analysis of each claim case.

### 1. Modeling Approaches

### 1.1. Supervised Machine Learning

In the realm of data analysis, supervised machine learning stands out as a powerful tool, particularly when dealing with labeled datasets. Consider, for instance, the challenge of distinguishing fraudulent claims from legitimate ones. By leveraging features like the requested quantity and the approved quantity, supervised machine learning algorithms can build models that are capable of making informed predictions. These algorithms, such as Logistic Regression, Decision Trees, and XGBoost, are designed to identify patterns and trends within the data, enabling us to make more informed decisions and enhancing our ability to detect and prevent fraudulent claims. In essence, they provide a framework for understanding and predicting outcomes based on historical data, making them invaluable tools in the fight against claim fraud.

### XGBoost Explanation

Ensemble methods in machine learning involving combining multiple models and learning from mistakes. Tree boosting is a highly effective and widely used machine learning method. XGBoost is a scalable tree boosting system that is widely used by data scientists and provides state-of-the-art results on many problems. In simple words XGBoost models the data with n number of decision tree model with each model learning from the mistake of previous model (hence called boosting).

With reference to FIG. 1, in boosting, the trees are built sequentially such that each subsequent tree aims to reduce the errors of the previous tree. Each tree learns from its predecessors and updates the residual errors. Hence, the tree that grows next in the sequence will learn from an updated version of the residuals.

The base learners in boosting are weak learners in which the bias is high, and the predictive power is just a tad better than random guessing. Each of these weak learners contributes some vital information for prediction, enabling the boosting technique to produce a strong learner by effectively combining these weak learners. The final strong learner brings down both the bias and the variance.

In contrast to bagging techniques like Random Forest, in which trees are grown to their maximum extent, boosting makes use of trees with fewer splits. Such small trees, which are not very deep, are highly interpretable. Parameters like the number of trees or iterations, the rate at which the gradient boosting learns, and the depth of the tree, could be optimally selected through validation techniques like k-fold cross validation. Having a large number of trees might lead to overfitting. So, it is necessary to carefully choose the stopping criteria for boosting.

The gradient boosting ensemble technique consists of three simple steps:
S1. An initial model F₀ is defined to predict the target variable y. This model will be associated with a residual (y−F₀);
S2. A new model h₁ is fit to the residuals from the previous step;
S3. F₀ and h₁ are combined to give F₁, the boosted version of F₀. The mean squared error from F1 will be lower than that from F₀:

$${F}_{1} ( x ) < - {F}_{0} ( x ) + {h}_{1} ( x )$$

To improve the performance of F₁, we could model after the residuals of F₁ and create a new model F₂:

$${F}_{2} ( x ) < - {F}_{1} ( x ) + {h}_{2} ( x )$$

This can be done for m′ iterations, until residuals have been minimized as much as possible:

$${F}_{m} ( x ) < - {F}_{m - 1} ( x ) + {h}_{m} ( x )$$

Here, the additive learners do not disturb the functions created in the previous steps. Instead, they impart information of their own to bring down the errors.

### Feature Engineering

Since in our dataset we have a lot of textual and categorical variables, it was required to engineer specific features from claims and approval data to be used in modeling. The table below summarizes the features we engineered to be used for modeling.

| Feature | Description |
|---|---|
| Gender | Gender of the applicant |
| Age | Age of applicant |
| Amount requested | Amount requested in claim |
| ICD code mismatch | Comparison between ICD code claimed |
| | with ICD-10 AM codes |
| SBS code mismatch | Comparison between SBS code claimed |
| | with gov provided billing codes |
| Reporting treatment day diff | Difference between reporting and |
| | treatment date |
| Provider type claim encoded | Category encoded provider type |
| FOB claim encoded | Category encoded type of claim |
| Assessment claim encoded | Category encoded ICD 10 AM code |
| Secondary Diagnosis claim | Category encoded ICD 10 AM code for |
| encoded | secondary diagnosis |
| Region claim encoded | Region of application |
| HCP Network claim encoded | Healthcare provider network |
| Service claim encoded | Type of service |
| Present in approval | Boolean showing if claim was present in |
| | approval |

### Loss Calculation

To calculate the loss incurred by each model, financial loss due to investigation and reputation damage were taken into account. Investigation cost and reputation cost was fixed at 20 and 80 respectively. Below are the four cases possible in model prediction and how loss would be calculated for each case.

Scenario 1: True Positive (TP)—When the model predicts the case is fraud and it is actually a fraud. We add the investigation cost to loss.

Scenario 2: True Positive (TN)—When the model predicts the case is legitimate and it is actually legitimate. No loss is added.

Scenario 3: True Positive (FP)—When the model predicts the case is fraud and it is actually a legitimate case. We add investigation cost and reputation cost to loss.

Scenario 4: FN—When the model predicts the case is legitimate and it is actually a fraudulent case. We add reputation cost to loss.

### 1.2. Unsupervised Machine Learning

When it comes to exploring unlabeled data, unsupervised machine learning algorithms play a pivotal role. These algorithms are designed to identify hidden patterns and clusters within vast datasets, without the need for labeled examples. While evaluating their performance can be tricky due to the absence of a ground truth, they can still serve as valuable tools for performance benchmarking, especially when labels are available. In our context, an unsupervised approach can help us gain insights into the structure and relationships within our data, enabling us to make more informed decisions. Popular examples of unsupervised machine learning algorithms include K-means clustering and DBSCAN, which help us identify clusters of similar data points and detect outliers, respectively. By leveraging these tools, we can gain deeper insights into our data, enhance our understanding of fraudulent claim patterns, and take proactive measures to prevent them.

### K-means Clustering

### Simplifying Data for Enhanced Understanding

Within the realm of unsupervised learning, K-means clustering serves as a fundamental approach to simplify complex datasets not by reducing dimensionality, but by consolidating numerous data points into manageable groups. The challenge that K-means addresses is the sheer volume of data points which can be overwhelming for both analytical algorithms and human analysts.

K-means clustering achieves data simplification by partitioning the dataset into a pre-defined number of clusters. Each cluster is defined by its central point, known as the centroid, to which the data points are associated based on proximity. This process entails an iterative refinement where centroids are recalculated and points re-associated until the optimal layout of clusters is achieved.

An illustrative example of the practical application of K-means is in the detection of fraudulent medical claims. In this context, K-means can be deployed to segment claims into clusters based on similarities in patient profiles, treatment codes, billing patterns, and other relevant features. Once clustered, these groups can be analyzed to identify patterns that deviate from the norm. For instance, a cluster that shows an unusual frequency of certain treatments or anomalously high costs could signal potential fraud or administrative errors.

By effectively reducing the number of data points to a set of meaningful clusters, K-means provides a clear overview of the data. This overview is invaluable in fields like healthcare, where it can be used to spot inconsistencies, streamline patient care, and ensure the integrity of billing practices. It exemplifies how K-means clustering not only aids in data reduction but also serves as a critical tool in uncovering and understanding the underlying structure within the data.

### Cluster-Based Data Representation

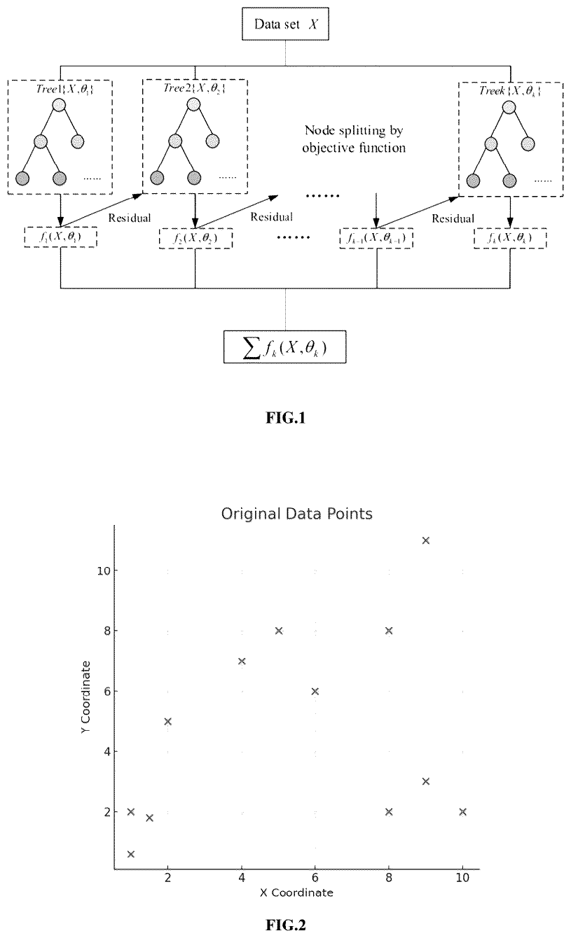

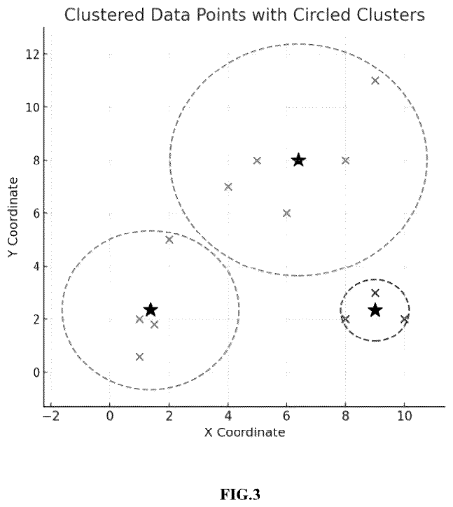

A straightforward method to streamline a dataset is to group similar points together into clusters. Consider a set of two-dimensional data points, as depicted in the accompanying FIG. 2. Observing this data, one can discern that it naturally segregates into three distinct clusters. This clustering is instinctive to us because our minds are equipped with pattern recognition capabilities akin to clustering algorithms.

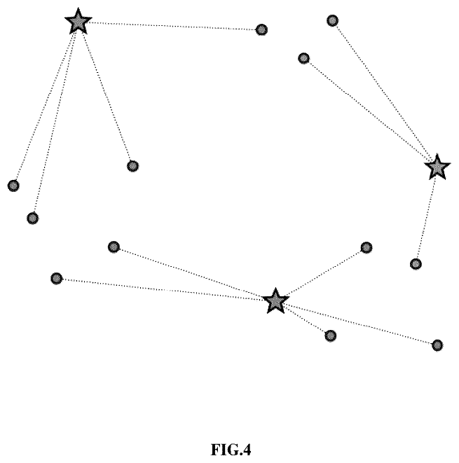

With reference to FIG. 3, we have superimposed a visual delineation of each cluster over the data. Boundaries for each cluster are marked with uniquely colored solid lines, and the center of each cluster is indicated with a star symbol matching the color of the boundary. In machine learning terminology, these central points are called cluster centroids. By focusing on the centroids, we can view the dataset more broadly—rather than as 10 individual points, we see it as being composed of 3 key centroids, each representing a subset of the data.

To mathematically describe what we intuitively observe, let's introduce some notation. We will represent our dataset of 10 points (P=10) in two dimensions (N=2) as x1, x2, . . . , xP. The number of clusters, K, in this case, is 3. Each cluster has a central point, or centroid, which we'll denote as c1, c2, . . . , cK, where ck is the centroid of the kth cluster. We'll also define the set of indices for points in the kth cluster as Sk.

With this notation, we can mathematically articulate the clustering depicted in the figure. Assuming we've identified each cluster and its centroid visually, we understand that a centroid should be the average of the points within its cluster. Algebraically, we express this as:

$${c}_{k} = \frac{1}{\vert {S}_{k} \vert} {\sum }_{p ϵ {S}_{k}} {x}_{p}$$

This equation validates our understanding that each centroid is an average—a representative chunk of the dataset.

Furthermore, we can assert that each data point is affiliated with the cluster of the nearest centroid. Mathematically, for a given point xp, this means it belongs to the cluster where the distance to the centroid, denoted as ∥xₚ−cₖ∥₂ the smallest. Hence a point xp is assigned to cluster k if aₚ=argmin_{k=1, . . . , K}∥xₚ−cₖ|₂.

In the language of machine learning, we refer to this process as cluster assignments.

### Data Clusters Through K-Means

Identifying clusters within a dataset by eye is not feasible when dealing with more than three dimensions, which is often the case with complex data. To bypass this limitation, we employ the K-means clustering algorithm. This algorithm is a practical application of the mathematical framework used for defining clusters. K-means operates through an iterative process, continuously refining the positions of cluster centroids and the grouping of data points until an optimal configuration is reached.

Imagine we have a dataset consisting of ‘P’ data points, and we aim to organize them into ‘K’ distinct clusters. We decide on the number ‘K’ in advance, and later we'll explore the best way to choose this number. Initially, we don't know the centroid locations of these clusters or which points belong to them.

To begin, we make an educated guess about the positions of the ‘K’ centroids. This guess might be as simple as randomly picking ‘K’ data points to serve as the initial centroids. With these preliminary centroids in place, we then assign each data point to the nearest centroid using the specified formula:

$${a}_{p} = {argmin}_{k = 1 , … , K} {‖ {x}_{p} - {c}_{k} ‖}_{2}$$

This results in our first round of cluster assignments. Next, we refine the centroids by recalculating their positions to be the mean of all points assigned to their cluster:

$${c}_{k} = \frac{1}{\vert {S}_{k} \vert} {\sum }_{p ϵ {S}_{k}} {x}_{p}$$

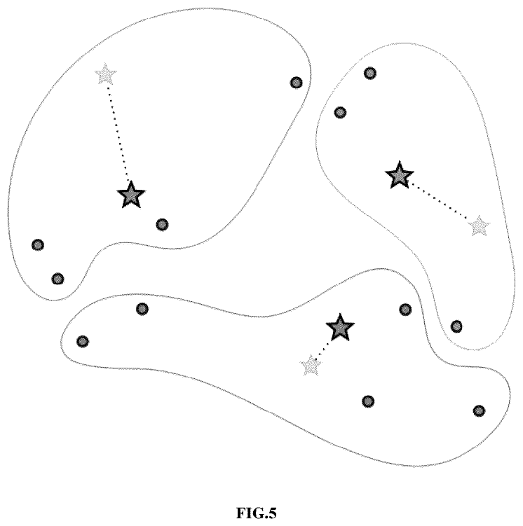

In the FIG. 4-5, we can see the visualization of these initial steps: choosing the initial centroids, assigning points to clusters, and then recalculating the centroid locations. By repeating the cycle-reassigning points to the newest centroids and then updating those centroids based on the current assignments-we fine-tune the clustering. This iterative cycle continues until the centroids stabilize and no longer shift significantly, indicating that the clusters have been clearly defined and the algorithm has converged.

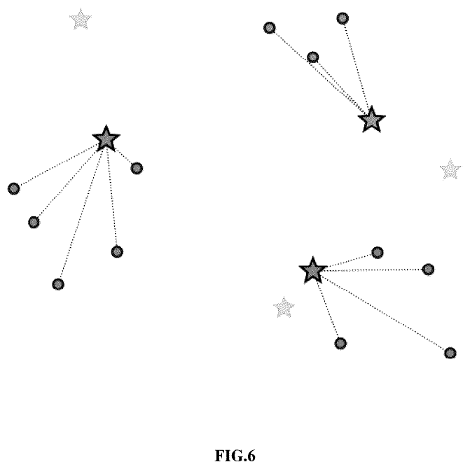

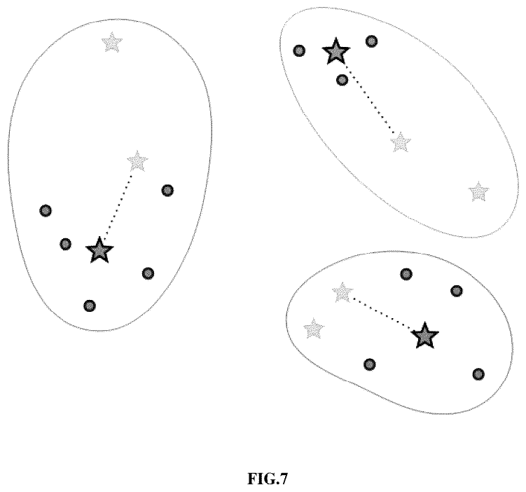

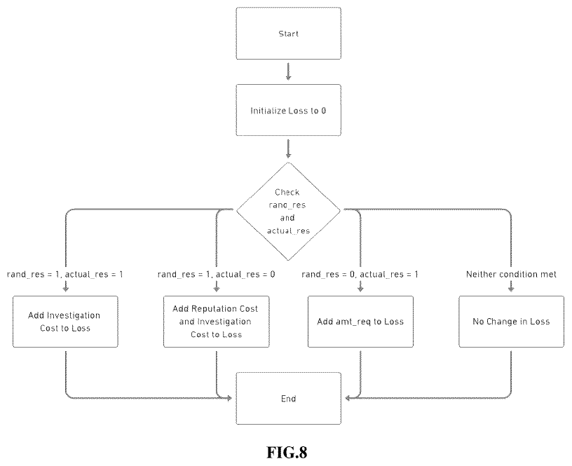

FIG. 6-7 illustrate the process: the left shows the assignment of points to their respective centroids, and the right shows the updated positions of the centroids after recalculating their averages based on the assigned points. Through this method, K-means clustering makes it possible to uncover the hidden structure in complex datasets without the need for manual classification.

### Data Preparation and Clustering Approach:

Prior to modeling, the data underwent essential preprocessing steps, including the removal of non-essential columns and the imputation of missing values. Two distinct K-means models were employed for the analysis: one configured with three clusters and the other with two clusters. Each model was carefully fitted to the claims data, taking into account the intricacies and patterns present in the dataset.

### Outlier Identification and Evaluation:

Post-clustering, we calculated the distance of each claim from its nearest cluster centroid, a key step in identifying potential outliers in the data. A threshold was set at the 95th percentile of these distances, distinguishing between regular data points and those that may indicate fraudulent activity. Claims flagged as outliers based on this threshold were then marked in our dataset, enabling a direct comparison with the actual labels of fraudulence.

### Performance Metrics and Insights

The effectiveness of the K-means models was assessed by determining the percentage of accurately identified fraudulent claims among the outliers. Both the three-cluster and two-cluster models showed similar capabilities in detecting fraudulent claims. However, the detection covered only a portion of the total fraudulent claims present in the data. Additional insights were drawn by incorporating a unique feature in the claims dataset related to the quantity requested and approved. This feature was instrumental in defining an accurate label for actual fraudulent activity. The three-cluster model's success in identifying fraudulent claims was quantified, revealing it identified approximately 6.52% of the actual frauds in the dataset. The overall predictive accuracy of the model in the context of the entire dataset stood at around 66.62%.

### Loss Calculation for Fraud Detection Models

In machine learning, especially in supervised learning, a loss function is used to optimize the model during training. It measures the difference between the model's predictions and the actual values. However, in a business context, custom loss function can be used post-model evaluation to understand the financial impact of the model's prediction and to adjust the decision thresholds used by the model to flag transactions as fraudulent or legitimate.

Custom loss functions are particularly useful when standard loss functions (like mean squared error for regression, or cross-entropy for classification) do not align well with business objectives. By quantifying the impact of true positives, false positives, and false negatives in financial terms, a business can more accurately assess the value of the ML model and make more informed decisions.

FIG. 8 illustrates the process: the given calculate loss function is designed to calculate the financial impact of predictions made by a fraud detection model. It takes three parameters: amt_req which is the amount of money involved in the transaction, rand_res which is the model's prediction (1 for a flagged fraudulent transaction and 0 for a transaction not flagged), and actual_res which is the actual outcome (1 for an actual fraudulent transaction and 0 for a legitimate one)

Here's how the loss is calculated based on different scenarios:

True Positive (TP): The model correctly flags a fraudulent transaction. The loss incurred is equal to the investigation cost, as resources are spent to investigate the transaction.

False Positive (FP): The model incorrectly flags a legitimate transaction as fraud. The loss is the sum of the reputation cost (for incorrectly flagging a legitimate transaction, potentially damaging customer relations) and the investigation cost.

False Negative (FN): The model fails to flag a fraudulent transaction. The loss is the amount requested in the fraudulent transaction, as this money is lost due to the fraud not being detected.

True Negative (TN): The model correctly identifies a legitimate transaction, incurring no loss (not included in the function as it does not add to the loss).

The calculate loss function is a simplistic model for financial loss in fraud detection, not accounting for indirect costs such as the impact on customer experience or long-term brand reputation damage from FPs, nor the potential legal and compensatory costs arising from FNs.

The loss calculation aggregated Function:

This function aggregates the losses across different predictive models. It iterates over a set of models, applying the calculate loss function to each one to compute the total financial impact based on their predictions.

### Process:

Iterates through each model (e.g., perfect model, various random forest models, XGBoost, K-means).

For each model, it computes the total loss by applying the calculate loss function to each transaction, considering the model's prediction, the perfect model's prediction, and the transaction amount.

Records and prints the total loss for each model and the overall total amount requested in transactions.

Although the above discussion discloses various exemplary embodiments of the invention, it should be apparent that those skilled in the art can make various modifications that will achieve some of the advantages of the invention without departing from the true scope of the invention.

### 1.3. Generative AI

Generative AI refers to a subset of artificial intelligence models and techniques that are designed to generate new content that is similar to the content on which they have been trained. This can include text, images, music, speech, videos, and other forms of media or data. Generative AI systems learn the patterns, styles, or features of a specific dataset and can then use that understanding to generate new, original pieces that have never been seen before but are plausibly similar to the training data.

### 1.3.1. Learning Process

Generative AI models, such as Generative Adversarial Networks (GANs), Variational Autoencoders (VAEs), and Transformer-based models like GPT (Generative Pretrained Transformer), learn by analyzing vast amounts of training data.

### 1.3.2. Key Models

GANs: These consist of two neural networks, a generator and a discriminator, that are trained simultaneously through a competitive process. The generator creates new data instances, while the discriminator evaluates them against the real data, pushing the generator to improve.

VAEs: These are probabilistic models that learn the distribution of the data in a compressed representation and can generate new data by sampling from this learned distribution.

Transformer-based models: Originally designed for natural language processing tasks, they can generate coherent and contextually relevant text based on a given prompt, and have also been adapted for image and music generation.

### 1.3.3. Generative AI's Medical Knowledge

To evaluate one aspect of ChatGPT's potential utility, the researchers evaluated its performance on the USMLE, which consists of three standardized tests that medical students must pass to obtain a medical license.

To do this, the research team obtained publicly available test questions from sample exam released on the official USMLE website. Questions were then screened, and any question requiring visual assessment was removed.

From there, the questions were formatted in three ways: open-ended prompting, such as ‘What would be the patient's diagnosis based on the information provided?’; multiple choice single answer without forced justification, such as ‘The patient's condition is mostly caused by which of the following pathogens?’; or multiple choices single answer with forced justification, such as ‘Which of the following is the most likely reason for the patient's nocturnal symptoms?Explain your rationale for each choice.’

Each question was then put into the model separately to reduce the tool's memory retention bias.

During testing, the researchers found that the model performed at or near the passing threshold of 60 percent accuracy without specialized input from clinician trainers. They stated that this is the first time AI has done so.

The researchers also discovered upon evaluating the reasoning behind the tool's responses that ChatGPT displayed understandable reasoning and valid clinical insights, which led to increased confidence in trust and explainability.

The research team suggests that these findings highlight how ChatGPT and other LLMs may potentially assist human learners in medical education and be integrated into clinical settings, like Ansible Health's ongoing efforts to translate technical medical reports into more easily understandable language for patients using ChatGPT.

Generative AI possess knowledge about the relationship of drugs, medical procedures and the diagnosis and the chief complaints as documented by the medical providers. We applied ChatGPT 4 as our foundation model and first educate the agent with latest medical literatures and the drug description by FDA and we also feed the medical insurance claim guidelines and sample medical insurance contracts so the agent possesses information about the medical and insurance knowledge. We add such knowledge to the foundation AI model using an approach called Fine-tuning.

Fine-tuning is a technique in which pre-trained models are customized to perform specific tasks or behaviors. It involves taking an existing model that has already been trained and adapting it to a narrower subject or a more focused goal. For example, a pre-trained model that can generate natural language texts can be fine-tuned to write poems, summaries, or jokes. Fine-tuning allows us to leverage the general knowledge and skills of a large and powerful model and apply them to a specific field or objective.

Via a proprietary prompt engineering tested using 10,000 scenarios by prompt engineer, we ask the agent to help assess a case by reviewing if the medical procedure and drugs are medically necessary and to provide a commentary on areas that a normal claim assessor would find suspicious about a claim. the prompt utilizes expert panel discussion to mimic human debates to arrive at the best conclusion and our analysis shows significant improvement in accuracy comparing the first prompt to the finalized prompt.

The commentary given by generative AI includes the following as an example.

For each medical service requested:

| Row | | | | | | Risk | |
|---|---|---|---|---|---|---|---|
| No. | ICD1 | ICD2 | Claim ID | Item Code | Item Name | Flag | Medical Necessity |
| 89 | S43.4 | M75.1 | 60341 | 73100-09-80 | Unlisted | Red | The requested hematology and |
| | | | | | hematology and | | coagulation procedure is not |
| | | | | | coagulation | | directly related to the diagnosis |
| | | | | | procedure | | code S43.4 (shoulder sprain) or |
| | | | | | | | M75.1 (rotator cuff syndrome), |
| | | | | | | | nor is it related to their common |
| | | | | | | | symptoms such as pain, limited |
| | | | | | | | range of motion, and |
| | | | | | | | inflammation in the shoulder. |

For the overall claim case,
Item Name: \“Consultant Consultation\”—The amount requested for this service is significantly high compared to other services, which may warrant further investigation into the necessity and reasonableness of the consultation.
Item Name: \“Unlisted hematology and coagulation procedure\” and\“PTT Test\”—These laboratory services have identical quantities and amounts requested, which may require verification to ensure that they are not duplicate charges for the same test.
Item Name: \“Automated complete Blood cell count\”—The amount requested for this service is relatively high, and it may be necessary to review the reasonableness of the cost and the medical necessity of the test.

Quantity and Amount Requested Discrepancies—Some of the laboratory services have higher quantities and amounts requested compared to similar tests, which may indicate potential overutilization or billing discrepancies.

High Frequency of Laboratory Services—The number of laboratory services requested for a single outpatient visit appears to be relatively high, which could raise questions about possible overutilization or unnecessary testing.

1. A medical insurance claim fraud detection system comprising:
an unsupervised model, which learns by observing data and employs similarity and clustering analysis to identify abnormal behaviors and outliers;
a supervised model, which learns from human past decisions and mimics human reasoning in identifying fraud, wastage, and abuse, it utilizes machine learning techniques to understand the correlation between inputs and human decisions, establishing relationships without the need for rule engines;
a GenAI model, leveraging the power of generative AI with proprietary enhancements, this model possesses the latest medical and insurance knowledge, it adjudicates cases with human-like reasoning;
each of these models independently makes predictions about whether a claim case is fraudulent, wasteful, or abusive, prioritizing precision, it then combines the results of these three models, labeling a case as fraudulent, wasteful, or abusive through a weighted voting system.

2. The system of claim 1, wherein the K-means clustering algorithm is utilized for unsupervised learning, by consolidating numerous data points into manageable groups, each cluster is defined by its central point to which the data points are associated based on proximity.

3. The system of claim 2, wherein the K-means clustering achieves data simplification by partitioning the dataset into a pre-defined number of clusters, this process entails an iterative refinement where centroids are recalculated and points re-associated until the optimal layout of clusters is achieved.

4. The system of claim 1, wherein prior to modeling, the data underwent essential preprocessing steps, including the removal of non-essential columns and the imputation of missing values.

5. The system of claim 3, wherein two distinct K-means models were employed for the analysis: one configured with three clusters and the other with two clusters, each model was carefully fitted to the claims data, taking into account the intricacies and patterns present in the dataset, both the three-cluster and two-cluster models showed similar capabilities in detecting fraudulent claims. However, the detection covered only a portion of the total fraudulent claims present in the data, additional insights were drawn by incorporating a unique feature in the claims dataset related to the quantity requested and approved, this feature was instrumental in defining an accurate label for actual fraudulent activity, the effectiveness of the K-means models was assessed by determining the percentage of accurately identified fraudulent claims among the outliers.

6. The system of claim 4, wherein XGBoost is utilized for supervised learning, XGBoost models the data with n number of decision tree model with each model learning from the mistake of previous model, In boosting, the trees are built sequentially such that each subsequent tree aims to reduce the errors of the previous tree, each tree learns from its predecessors and updates the residual errors.

7. The system of claim 1, wherein generative AI refers to a subset of artificial intelligence models and techniques that are designed to generate new content that is similar to the content on which they have been trained, this can include text, images, music, speech, videos, and other forms of media or data.

8. The system of claim 7, wherein generative AI models is generative adversarial networks, variational autoencoders, and transformer-based models, learn by analyzing vast amounts of training data.

9. The system of claim 8, wherein
generative adversarial networks: these consist of two neural networks, a generator and a discriminator, that are trained simultaneously through a competitive process, the generator creates new data instances, while the discriminator evaluates them against the real data, pushing the generator to improve;
variational autoencoders: these are probabilistic models that learn the distribution of the data in a compressed representation and can generate new data by sampling from this learned distribution;
transformer-based models: originally designed for natural language processing tasks, they can generate coherent and contextually relevant text based on a given prompt, and have also been adapted for image and music generation.

10. The system of claim 9, wherein the latest ChatGPT 4 model by OpenAI is utilized for GenAI model.
